(19) United States
(12) Patent Application Publication
(10) Pub. No.: US 2026/0174269 A1
(43) Pub. Date: Jun. 25, 2026

(54) EXTRACTOR AND EXTRACTION SYSTEM

(71) Applicant: Katsunori ICHIKI, Chiba (JP)

(72) Inventor: Katsunori ICHIKI, Chiba (JP)

(21) Appl. No.: 19/429,641

(22) Filed: Dec. 22, 2025

(30) Foreign Application Priority Data
Dec. 21, 2024 (JP) JP2024-225865

(51) Int. Cl. A47J 31/38; A47J 31/32; A47J 31/46

(52) U.S. Cl. CPC A47J 31/38; A47J 31/32; A47J 31/461

(57) ABSTRACT

This invention easily provides a strong extract at high reproducibility. An extractor includes a tubular member, a bottom surface member that is attached to a lower opening portion of the tubular member and used to install a filter for an extraction target, and a plunger that is inserted into the tubular member and can slidably move in a vertical direction in the tubular member, the plunger including an upper opening portion and a lower opening portion, wherein in a state in which the extraction target is placed on the filter installed on the bottom surface member attached to the tubular member, hot water is poured from the upper opening portion of the plunger, and the plunger is then pushed in while the upper opening portion is closed, thereby extracting an extract of the extraction target.

This application is based upon and claims the benefit of priority from Japanese patent application No. 2024-225865, filed on Dec. 21, 2024, the disclosure of which is incorporated herein in its entirety by reference.

### BACKGROUND OF THE INVENTION

### Field of the Invention

The present invention relates to an extractor used to extract an extract from an extraction target, and an extraction system.

### Description of the Related Art

In the above technical field, patent literature 1 discloses an apparatus capable of controlling a coffee extraction time by the pressing force of a hand.

[Patent Literature 1] Japanese Patent Laid-Open No. 2017-121335

### SUMMARY OF THE INVENTION

However, the technique described in the above literature does not assume repeatedly bringing hot water into contact with the coffee powder in divided portions. Instead, the entire amount of hot water is brought into contact with the coffee beans at once, therefore coffee extract cannot sufficiently be extracted. On the other hand, to bring hot water repeatedly into contact with the coffee beans little by little, it is necessary to remove a pump 4 and then pour hot water from above the main body, and this takes time. Alternatively, a complex configuration as shown in FIG. 12 of patent literature 1 is needed.

The present invention provides a technique of solving the above-described problem.

In order to achieve the above-described object, one example aspect of the present invention provides an extractor comprising:
a tubular member;
a bottom surface member that is attached to a lower opening portion of the tubular member and used to install a filter for an extraction target; and
a plunger that is inserted into the tubular member and can slidably move in a vertical direction in the tubular member, the plunger including an upper opening portion and a lower opening portion,
wherein in a state in which the extraction target is placed on the filter installed on the bottom surface member attached to the tubular member, hot water is poured from the upper opening portion of the plunger, and the plunger is then pushed in while the upper opening portion is closed, thereby extracting an extract of the extraction target.

In order to achieve the above-described object, another example aspect of the present invention provides an extraction system comprising:
an extractor including:
a tubular member;
a bottom surface member that is attached to a lower opening portion of the tubular member and used to install a filter for an extraction target;
a plunger that is inserted into the tubular member and can slidably move in a vertical direction in the tubular member, the plunger including an upper opening portion and a lower opening portion; and
a cap that engages with the upper opening portion of the plunger and includes a through hole,
a tube that engages with the through hole of the cap;
a valve that controls a flow of hot water in the tube; and
a tank capable of adjusting a temperature,
wherein in a state in which the extraction target is placed on the filter installed on the bottom surface member attached to the tubular member, hot water in the tank is poured from the through hole of the cap via the tube, and the plunger is then pushed in, thereby extracting an extract of the extraction target.

According to the present invention, it is possible to easily provide a strong extract with high reproducibility.

### BRIEF DESCRIPTION OF DRAWINGS

FIG. 1 is a view showing the configuration of an extractor according to the first example embodiment;

FIG. 2 is a view showing an extraction model according to the second example embodiment;

FIG. 3 is a view showing the outer appearance of an extractor according to the second example embodiment;

FIG. 4 is a longitudinal sectional view showing the configuration of the extractor according to the second example embodiment;

FIG. 5 is a longitudinal sectional view showing the configuration of the extractor according to the second example embodiment;

FIG. 6 is a partially enlarged view showing the configuration of the extractor according to the second example embodiment;

FIG. 7 is a view showing the effect of the extractor according to the second example embodiment;

FIG. 8 is a longitudinal sectional view showing the configuration of an extractor according to the third example embodiment;

FIG. 9 is a longitudinal sectional view showing the configuration of an extractor according to the fourth example embodiment;

FIG. 10 is a longitudinal sectional view showing the configuration of an extractor according to the fifth example embodiment; and

FIG. 11 is a longitudinal sectional view showing the configuration of an extraction system according to the sixth example embodiment.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise. An extraction target here is a concept including all substances from which an extract can be extracted, such as coffee powder, tea leaf, and broth powder.

### First Example Embodiment

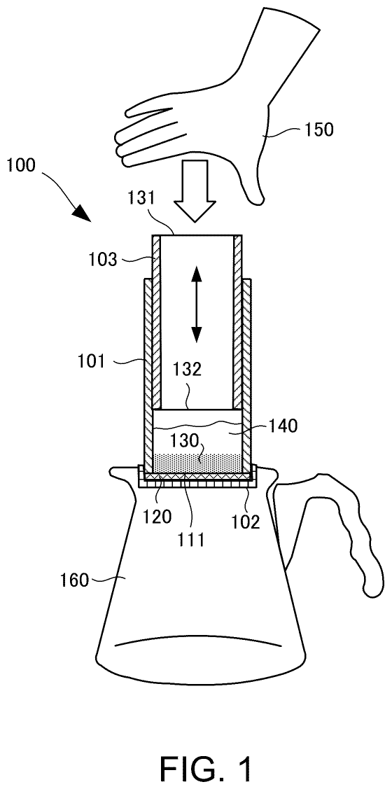

An extractor 100 according to the first example embodiment of the present invention will be described with reference to FIG. 1. The extractor 100 is a device configured to extract an extract from an extraction target such as coffee powder or tea.

FIG. 1 is a longitudinal sectional view of the extractor 100. As shown in FIG. 1, the extractor 100 includes a tubular member 101, a bottom surface member 102, and a plunger 103.

The bottom surface member 102 is attached to a lower opening portion 111 of the tubular member 101. A filter 120 for an extraction target is installed on the bottom surface member 102.

The plunger 103 is inserted into the tubular member 101 and can slidably move in the vertical direction in the tubular member 101, and includes an upper opening portion 131 and a lower opening portion 132.

In a state in which an extraction target 130 is placed on the filter 120 installed on the bottom surface member 102 attached to the tubular member 101, hot water 140 is poured from the upper opening portion 131 of the plunger 103, and the plunger 103 is then pushed in while the upper opening portion 131 is closed by a hand 150 or the like, thereby extracting the extract of the extraction target.

According to this example embodiment, since hot water can be poured very easily, and the extraction time can easily be adjusted, it is possible to extract only a soluble component from the extraction target at a favorable strength.

### Second Example Embodiment

### (Technical Premise)

First, the taste of coffee is composed of various components, including those responsible for sweetness, acidity, bitterness, and other miscellaneous flavors. The sweetness and the sourness, which have high hydrophilicity, readily dissolve out, but the bitterness and miscellaneous taste, which have low hydrophilicity (high lipophilicity), are difficult to dissolve out. If the temperature of hot water is high or the extraction time is long, bitterness/astringency with high lipophilicity are undesirably extracted. It is therefore important to extract an extract using hot water at a low temperature in a short extraction time (within a target extraction completion time) because this leads to extracting sweetness and sourness as much as possible from an extraction target (for example, coffee powder). On the other hand, if a large amount of hot water is made to touch the extraction target for a short time, the concentrations of the sweetness and the sourness lower. Hence, it is necessary to make a small amount of hot water touch the extraction target repetitively for a short time and set the entire extraction time to a predetermined time (target extraction completion time) or less.

Based on this, a case where a coffee liquid is extracted from coffee powder that is an example of an extraction target will be described. A paper drip type coffee extraction method that is generally used has the following problems.
(1) The purpose of the first pour (steaming step) is to wet whole powder with hot water, remove carbon dioxide gas contained in the powder, and increase a components extraction amount. However, without sufficient touch between the hot water and the powder, the hot water passes through the powder and readily passes through and leaks from a paper filter without extraction. For this reason, it requires skill to slowly pour hot water in a thin stream during the first pour.
(2) From the third shot of pouring, the paper filter is readily clogged.

To prevent the clogging and increase the reproducibility of taste, a skill is needed to pouring.
(3) To extract coffee with proper flavor, the extraction time is a major parameter. This is because if the extraction time from the first shot of pouring to completion of extraction is too short, coffee lacks depth of flavor, and if the extraction time is too long, bitterness and other miscellaneous tastes are generated. In a case of the paper drip method, however, once the process is started, it is impossible to adjust the filtration speed halfway through such that the extraction time satisfies a target value. The extraction time is a result, and the extraction time is almost subordinately determined by the grind size of beans determined first. However, the grind size of beans is a functional element in which diffusion and permeation are contradictory and therefore readily deviates from an optimum value.
(4) When hot water is poured, immersion, dissolution, diffusion, and filtration progress simultaneously. This is an advantage of the paper drip method that can complete extraction by minimal operations in a short time. On the other hand, if extraction is done using hot water of low temperature (83° C. or less) appropriate for extracting sourness and sweetness, weak coffee is extracted. This is because even if the immersion time is increased, the filtration speed cannot be controlled.

For this reason, a person who is skillful in pouring can make coffee of predetermined quality every time. However, a beginner can make tasty coffee one day but makes rather unsatisfactory coffee another day.

This example embodiment has as its object to solve the following challenging elements.
Challenge 1: In the steaming step, hot water is made to touch whole powder such that hot water that has not touched the powder is not discharged.
Challenge 2: No skill is needed to pour hot water.
Challenge 3: The immersion time/filtration speed can be controlled such that extraction is completed in a set time.

To satisfy challenges 1 and 2, an immersion method is used in which coffee powder is mixed with hot water and, in this state, temporarily stored in a space with a predetermined capacity. This makes it possible to make the hot water touch the whole powder regardless of how to pour hot water. In addition, the hot water that does not touch the powder during steaming does not leak to the downstream side.

For challenge 3, the aim is to control the extraction flow amount to be filtered to constant and complete extraction in a planned extraction time.

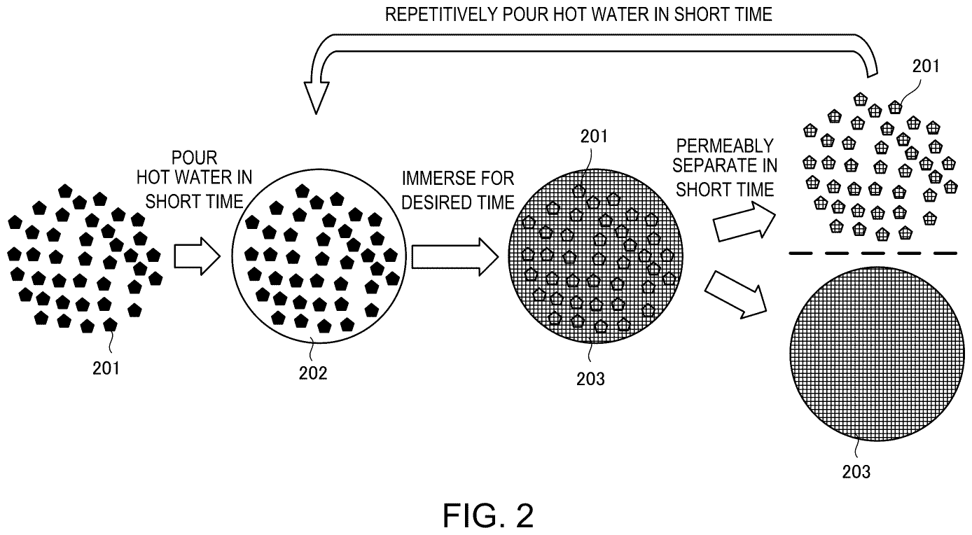

FIG. 2 is a schematic view of an extraction model according to this example embodiment. To perform immersion of coffee powder 201 in hot water 202 for a desired time and accurately control the time, pouring is performed in a short time and, after the immersion, the coffee powder 201 and an extract 203 are separated by filtration in a short time. Permeation is prevented from occurring at the same time as the immersion.

### (Configuration)

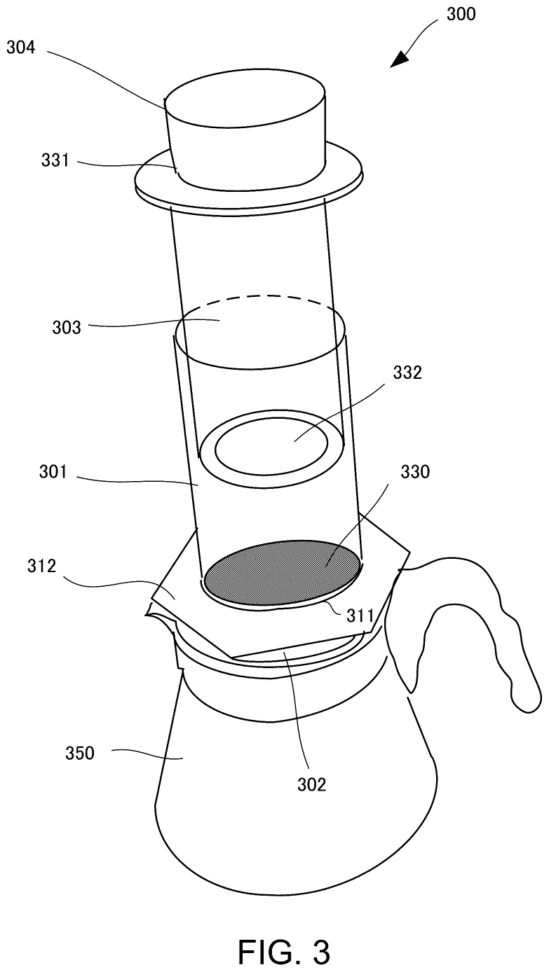

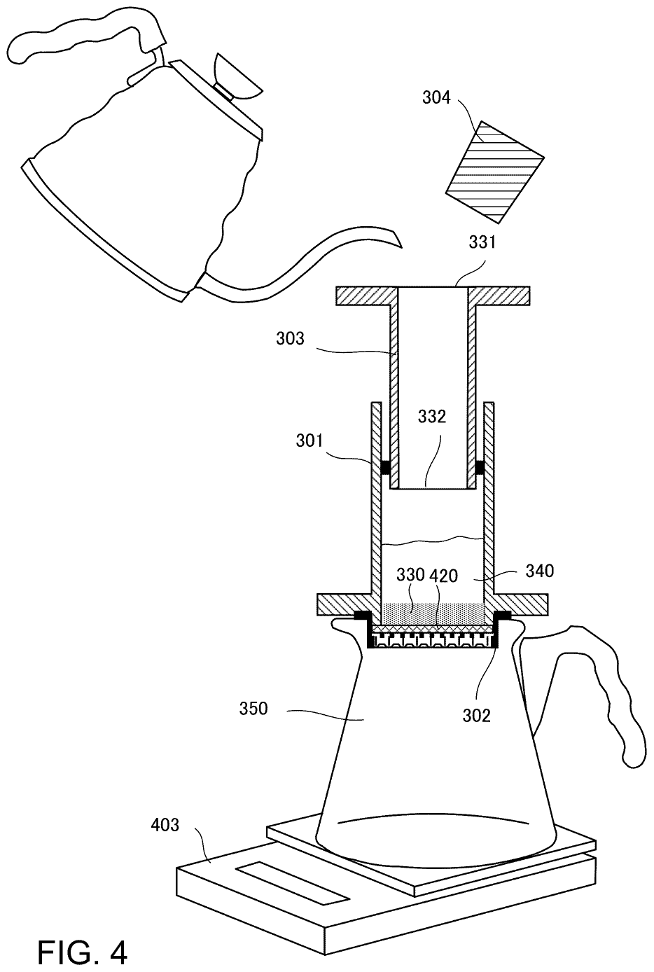

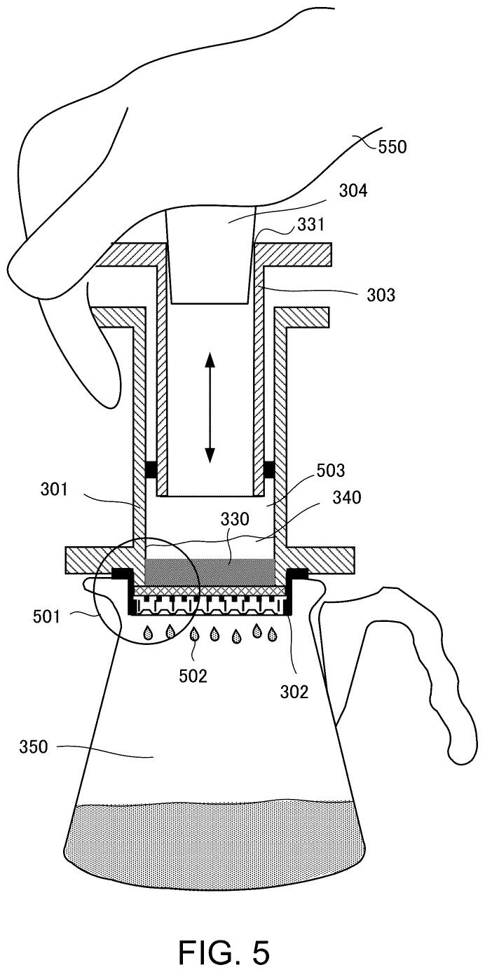

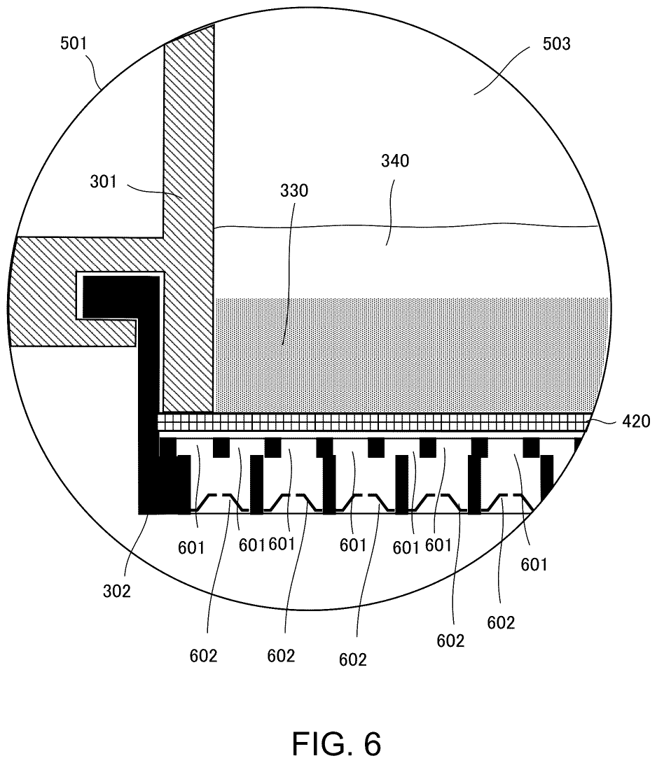

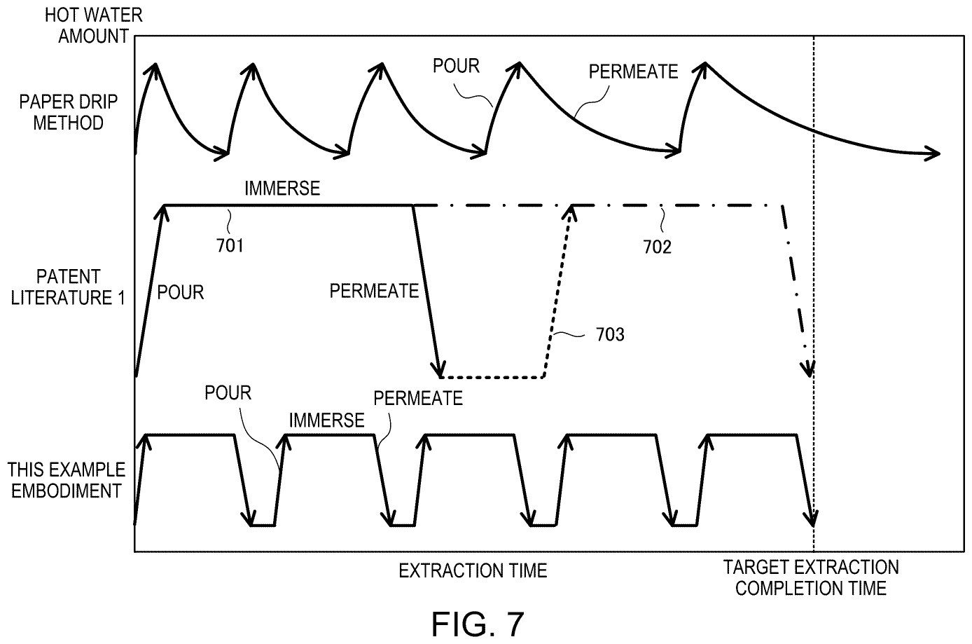

An extractor 300 according to the second example embodiment of the present invention will be described with reference to FIGS. 3 to 7. FIG. 3 is a view showing the outer appearance of the extractor 300 according to this example embodiment. FIGS. 4 and 5 are longitudinal sectional views of the extractor 300. FIG. 6 is a partially enlarged view of the extractor 300. FIG. 7 is a view showing the effect of this example embodiment. To extract a thick extract in a short time at a low temperature, as described above, a configuration capable of performing “multiple pouring” and performing permeation at an “appropriate pressure” is employed.

As shown in FIG. 3, the extractor 300 includes a tubular member (cylinder) 301, a bottom surface member 302, a plunger 303, and a cap 304. Here, the members have a cylindrical shape or a substantially columnar shape. However, the present invention is not limited to this, and the members may have a square tubular shape or a substantially square columnar shape.

The tubular member 301 is formed by a transparent member such that the inside can be seen. The bottom surface member 302 is a filter cap attached to a lower opening portion 311 of the tubular member 301. A filter for an extraction target is installed on the bottom surface member 302 and, for example, coffee powder (or tea leaf) 330 is placed on it. The portion between the bottom surface member 302 and the tubular member 301 is sealed, thereby forming a structure in which the coffee powder 330 stored in the tubular member 301 and hot water poured to the coffee powder 330 do not leak. The interior of the tubular member 301 thus functions as an immersion chamber.

The plunger 303 is inserted from above into the tubular member 301 and can slidably move in the vertical direction in the tubular member 301. The plunger 303 includes an upper opening portion 331 and a lower opening portion 332. The portion between the outer periphery of the plunger 303 and the inner periphery of the tubular member 301 is sealed, thereby forming an enclosed space inside the tubular member 301. When the plunger 303 is slidably moved downward, the capacity of the enclosed space can be reduced.

The cap 304 engages with the upper opening portion 331 of the plunger 303.

As shown in FIG. 4, in a state in which the coffee powder 330 is placed on a filter 420 installed on the upper surface of the bottom surface member 302 attached to the tubular member 301, hot water is poured from the upper opening portion 331 of the plunger 303 to immerse the coffee powder. When a scale 403 with stopwatch is arranged under a coffee server 350, pouring can be performed while confirming the weight, and the time elapsed from the pouring can be measured. Preferably the immersion chamber is lightly shaken to stir the hot water and the coffee powder only after the first pouring.

The extract of the coffee or tea is extracted in this state, and hot water containing the extract (that is, a coffee liquid) is generated. After that, as shown in FIG. 5, in a state in which the upper opening portion 331 is closed by the cap 304, the cap 304 and the plunger 303 are pushed in downward by a hand 550.

Since this decreases the capacity in the plunger 303 and the tubular member 301, the pressure (the pressure applied to the upper surface of hot water 340) in an immersion chamber 503 increases, and a coffee liquid 502 drops from the bottom surface member 302 to the coffee server 350.

FIG. 6 is an enlarged view of a portion 501 in FIG. 5. The bottom surface member 302 includes a smooth upper surface to set the filter 420. A plurality of liquid passage holes 601 are provided in the upper surface. Pressure actuated valves 602 that are normally closed but open when the immersion chamber 503 is pressurized to a predetermined pressure or more are provided under the liquid passage holes 601, thereby forming a structure in which a liquid that has passed through the liquid passage holes 601 is temporarily blocked by the pressure actuated valves 602. That is, the hot water 340 poured into the immersion chamber 503 passes through the filter 420 and the liquid passage holes 601 but can stay without passing through the pressure actuated valves 602.

If it reaches a desired immersion time and the plunger 303 is pressed downward by a hand 550 together with the cap 304, the plunger 303 slides downward in the tubular member 301, and the pressure in the immersion chamber 503 becomes high. If the pressure in the immersion chamber 503 exceeds the operating pressure of the pressure actuated valves 602, the pressure actuated valves 602 open, and the coffee liquid 502 is dripped from the bottom surface member 302 to the coffee server 350.

If the coffee liquid 502 in the immersion chamber 503 is almost entirely dripped into the coffee server 350, the user detaches the cap 304, holds the side surface of the plunger 303, and raises it up to the upper portion of the tubular member 301. Then, hot water is poured again.

The above-described steps of pouring, immersion, and permeation are repeated a plurality of times, thereby controlling such that extraction is ended in the target extraction completion time.

FIG. 7 is a view showing pouring, immersion, and permeation periods and timings in the paper drip method, patent literature 1, and this example embodiment.

In the paper drip method, permeation starts at the same time as pouring. The flow amount in permeation is proportional to the square root of the water head pressure. The flow velocity lowers at the end of permeation, and additionally, the fibers of the filter 420 are clogged every time the pouring count increase, and the permeation time becomes long due to a pressure loss. For this reason, it is difficult to complete extraction within a target extraction time, as above mentioned using FIG. 7, and it is also difficult to say that extract extraction from coffee powder is sufficiently performed.

On the other hand, the extractor of patent literature 1 is made on assumption that extraction is completed by one pouring. That is, this aims at shortening the immersion time and completing extraction before bitterness and other miscellaneous tastes are generated. However, an immersion time 701 is short in one pouring, and sweetness and sourness are not sufficiently extracted. Even if the immersion time is simply made long (alternate long and short dashed line 702), when the concentration of the extract extracted into hot water is close to the concentration of the extract in the coffee powder, extract elusion from the coffee powder stops based on the Fick's first law and, therefore, sweetness and sourness are not sufficiently extracted. Furthermore, even if pouring is to be repetitively performed using the extractor of patent literature 1, time and force are needed to draw the pump because the pressure in the cylinder is a negative pressure. As a result, since quick pouring cannot be performed (dotted line 703) and a sufficient immersion time cannot be ensured until the target extraction completion time, coffee lacks depth of flavor.

On the other hand, in this example embodiment, since a hybrid method of the immersion method and the permeation method is used, the immersion liquid can permeably be extracted, and pouring can quicky be performed divisionally a plurality of times. The hot water in which elusion is stopped is temporarily discharged from the immersion chamber, and new hot water is repetitively supplied, thereby effectively performing extraction of sourness and sweetness, which readily dissolve out, with high yield. As a result, the sourness and sweetness of coffee can be made strong.

As described above, according to this example embodiment, everybody can make strong coffee with high reproducibility. More specifically, fruity aroma of light roast and fresh bright sourness and sweetness are enhanced, and bitterness and astringency are suppressed.

For maintaining the pressure in the immersion chamber 503 at a predetermined value or less, a pressure adjusting check valve (vent valve) may be provided on the side surface of the plunger 303. Reversely, to prevent the pressure in the immersion chamber 503 from changing to a negative pressure, a check valve in the reverse direction may further be provided on the side surface of the plunger 303.

### Third Example Embodiment

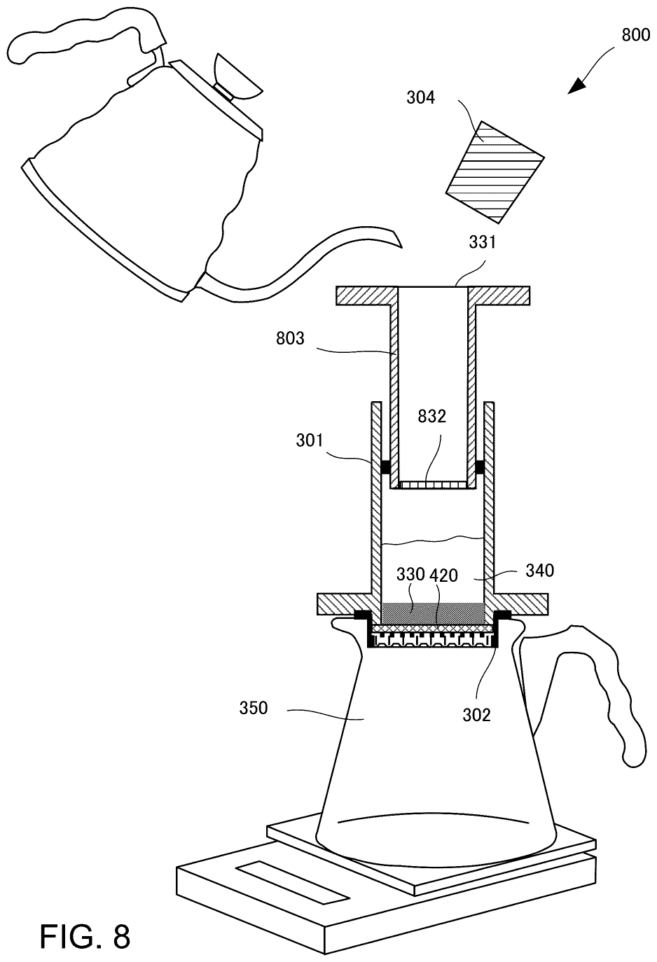

An extractor according to the third example embodiment of the present invention will be described next with reference to FIG. 8. FIG. 8 is a longitudinal sectional view for explaining the configuration of an extractor 800 according to this example embodiment. The extractor 800 according to this example embodiment is different from the second example embodiment in that a plunger 803 includes a mesh bottom surface portion 832. The rest of the components and operations is the same as in the second example embodiment. Hence, the same reference numerals denote the same components and operations, and a detailed description thereof will be omitted.

If hot water is vigorously poured from a kettle held high above the device, coffee powder is vigorously swirled up, a filter 420 is clogged by fine powder, and the permeation speed of a coffee liquid decreases. Also, when fat and oil themselves are partially peeled from the coffee powder surface by the force of the hot water and enter the coffee liquid, hydrophobic components such as bitterness and astringency increase too much, and the components of the taste of coffee are damaged.

A mesh member is installed on a lower opening portion 311 of the plunger 803, and the plunger 803 includes the mesh bottom surface portion 832. This prevents hot water poured into the plunger 803 from directly hitting coffee powder 330, and the hot water pours down to the coffee powder 330 lightly like a shower. As a result, it is possible to prevent the coffee powder 330 from swirling up and extract a coffee liquid without lowering the permeation speed.

In addition, if the mesh bottom surface portion 832 has a fine texture, and hot water is poured in a state in which the plunger 803 is placed at the lowermost portion, the hot water does not drip downward from the plunger 803 due to the surface tension of the mesh bottom surface portion 832 and temporarily stays in the plunger 803. When the plunger 803 is raised slowly, the pressure in an immersion chamber 503 changes to a negative pressure, and the hot water collected in the plunger 803 is poured, due to the pressure difference, to the coffee powder 330 very lightly, like a shower, from a very low position. As a result, it is possible to more reliably prevent the coffee powder 330 from swirling up, prevent the filter 420 from clogging, and extract a coffee liquid without lowering the permeation speed.

### Fourth Example Embodiment

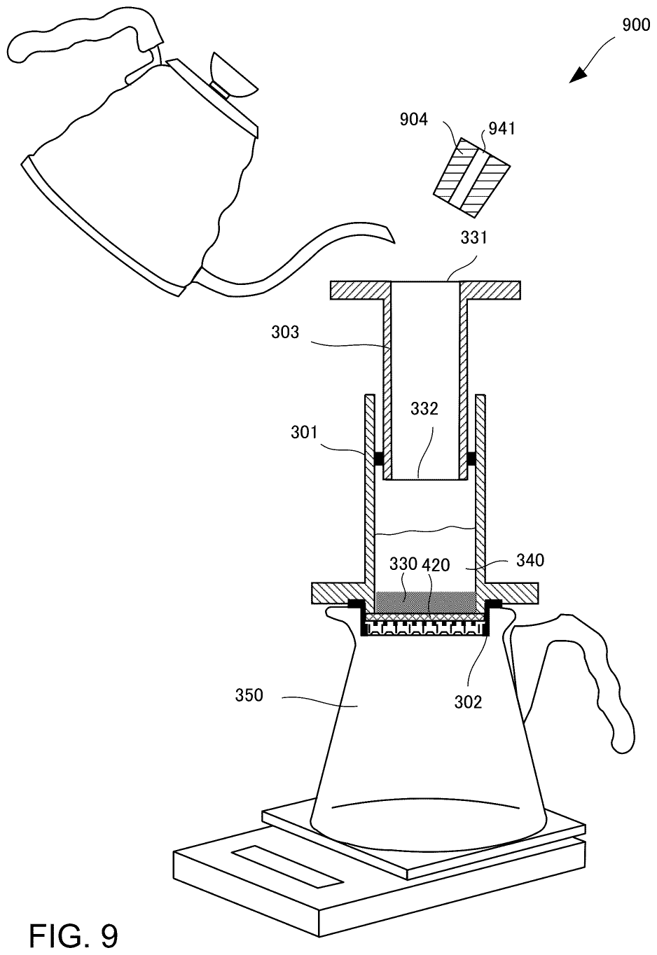

An extractor 900 according to the fourth example embodiment of the present invention will be described next with reference to FIG. 9. FIG. 9 is a view for explaining the configuration of the extractor 900 according to this example embodiment. The extractor 900 according to this example embodiment is different from the second example embodiment in that a cap 904 has a through hole 941. The rest of the components and operations is the same as in the second example embodiment. Hence, the same reference numerals denote the same components and operations, and a detailed description thereof will be omitted.

Since the through hole 941 that releases air in a plunger 303 to the outside is provided in the cap 904, the plunger 303 can be raised with the cap 904 kept attached. During pressing, the through hole 941 is closed by a hand, and the plunger is pushed in.

The through hole 941 is provided in the cap 904 here, but the through hole may be provided in the side surface of the plunger 303. When the through hole is sealed by a finger at the time of press and opened when raising the plunger 303, the plunger 303 can be moved upward without detaching the cap 904.

### Fifth Example Embodiment

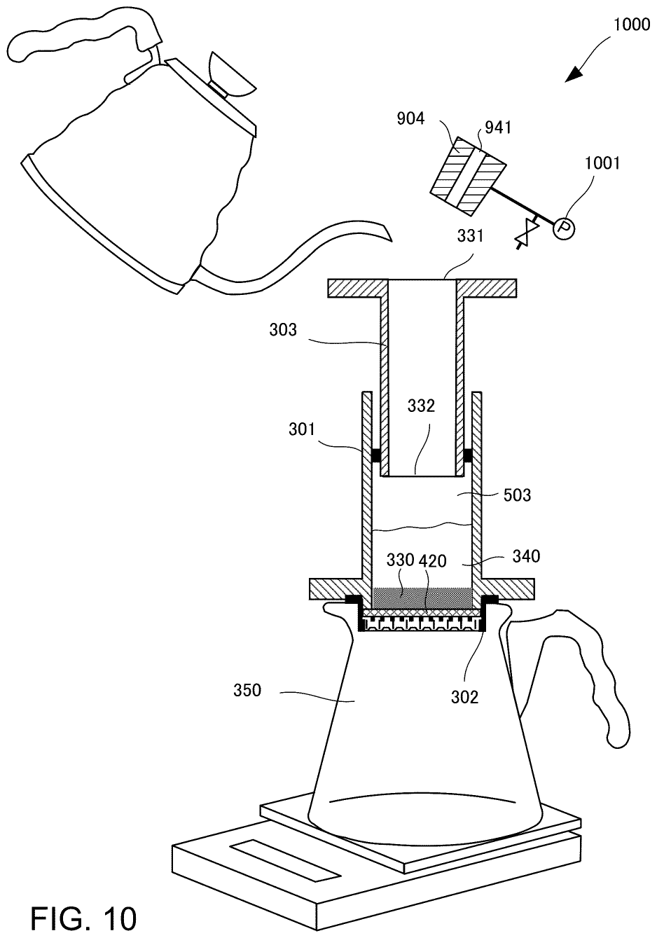

An extractor according to the fifth example embodiment of the present invention will be described next with reference to FIG. 10. FIG. 10 is a view for explaining the configuration of an extractor 1000 according to this example embodiment. The extractor 1000 according to this example embodiment is different from the fourth example embodiment in that a cap 904 includes a pressure gauge 1001. The rest of the components and operations is the same as in the second example embodiment. Hence, the same reference numerals denote the same components and operations, and a detailed description thereof will be omitted.

By the pressure gauge 1001, the pressure in an immersion chamber 503 can be displayed. That is, it is possible to press a plunger 303 such that the pressure in the immersion chamber 503 does not exceed a predetermined value or more and prevent extraction of bitterness and miscellaneous tastes from coffee powder. To keep the pressure in the plunger at a predetermined value or less, the cap 904 may include a vent valve.

### Sixth Example Embodiment

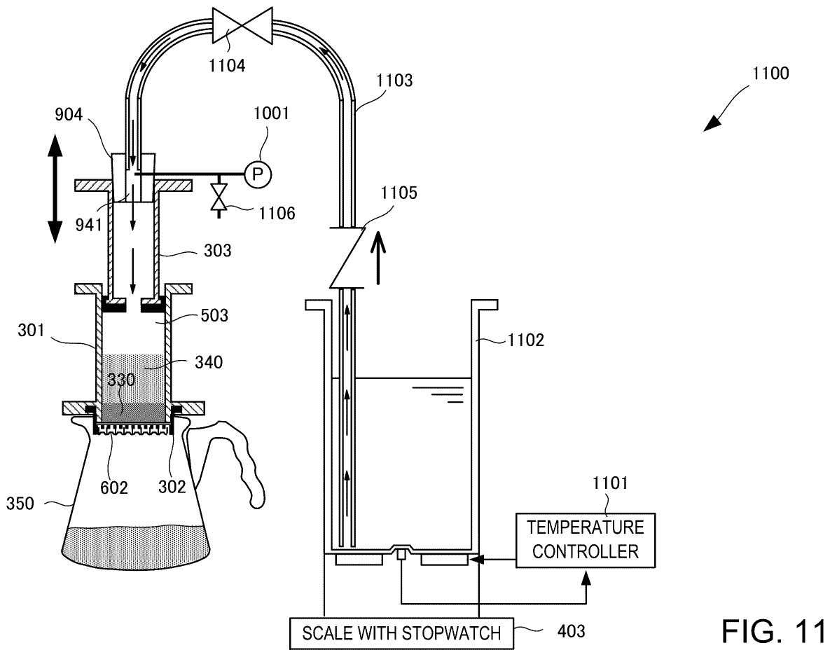

An extractor according to the sixth example embodiment of the present invention will be described next with reference to FIG. 11. FIG. 11 is a view for explaining the configuration of an extraction system 1100 according to this example embodiment. The extraction system 1100 according to this example embodiment is different from the fifth example embodiment in that pouring is semiautomatic. The rest of the components and operations is the same as in the second example embodiment. Hence, the same reference numerals denote the same components and operations, and a detailed description thereof will be omitted.

The extraction system 1100 includes a scale 403 with stopwatch, a kettle 1102 equipped with a temperature controller 1101, and a silicone tube 1103 that supplies hot water in the kettle 1102 to a through hole 941 of a cap 904. Also, the silicone tube 1103 is provided with a shutoff valve 1104 and a check valve 1105.

When a plunger 303 is pulled up in the extraction system 1100, the pressure in an immersion chamber 503 changes to a negative pressure, the check valve 1105 opens, and hot water in the kettle 1102 is poured into the immersion chamber 503. When the plunger 303 is pushed down at a planned immersion time, the check valve 1105 is closed, the immersion chamber 503 is pressurized, pressure actuated valves 602 of a bottom surface member 302 open, and a coffee liquid drops to a coffee server 350. After the plunger 303 is pushed down up to the lowermost portion, a vent valve 1106 is opened to remove the residual pressure in the immersion chamber 503. After that, when the plunger 303 is pulled up again, pouring is performed, and the process can be repeated from then on. The amount of poured hot water is measured by the weight of the kettle 1102 because the weight decrease, the measured value is negative.

Also, not only the check valve 1105 but also the shutoff valve 1104 is provided halfway through the silicone tube 1103. This can solve the problem that when air in the immersion chamber 503 filled with a vapor at the time of pouring is cooled during immersion, the pressure in the chamber changes to a negative pressure, and when the pressure difference exceeds the cracking pressure of the check valve 1105, the check valve 1105 opens to cause hot water in a predetermined amount or more to flow into the immersion chamber 503.

According to the extraction system 1100, it is possible to complete extraction in a target extraction completion time or less while pouring a small amount of hot water a number of times.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims. A system or apparatus including any combination of the individual features included in the respective example embodiments may be incorporated in the scope of the present invention.

The present invention is applicable to a system including a plurality of devices or a single apparatus.

What is claimed is:

1. An extractor comprising:
a tubular member;
a bottom surface member that is attached to a lower opening portion of said tubular member and used to install a filter for an extraction target; and
a plunger that is inserted into said tubular member and can slidably move in a vertical direction in said tubular member, said plunger including an upper opening portion and a lower opening portion,
wherein in a state in which the extraction target is placed on the filter installed on said bottom surface member attached to said tubular member, hot water is poured from said upper opening portion of said plunger, and said plunger is then pushed in while said upper opening portion is closed, thereby extracting a extract liquid from the extraction target.

2. The extractor according to claim 1, further comprising a cap that engages with said upper opening portion of said plunger and includes a through hole configured to allows air to escape in said plunger to the outside,
wherein in the state in which the extraction target is placed on the filter, the hot water is poured from said upper opening portion of said plunger or said through hole of said cap, and said plunger is then pushed in while closing said through hole of said cap, thereby extracting the extract of the extraction target.

3. The extractor according to claim 1, wherein said bottom surface member includes a pressure actuated valve configured to discharge the extract of the extraction target.

4. The extractor according to claim 2, wherein said plunger or said cap comprises a pressure gauge or a pressure actuated valve configured to keep a pressure in said tubular member at not more than a predetermined value.

5. The extractor according to claim 1, wherein said plunger includes a mesh bottom surface portion.

6. The extractor according to claim 2, further comprising:
a tube that engages with said through hole of said cap; and
a valve that controls a flow of the hot water in said tube.

7. The extractor according to claim 2, further comprising a vent valve that can be attached to said plunger or said cap to lower a pressure in said plunger.

8. An extraction system comprising:
an extractor including:
a tubular member;
a bottom surface member that is attached to a lower opening portion of said tubular member and used to install a filter for an extraction target;
a plunger that is inserted into said tubular member and can slidably move in a vertical direction in said tubular member, said plunger including an upper opening portion and a lower opening portion; and
a cap that engages with said upper opening portion of said plunger and includes a through hole,
a tube that engages with said through hole of said cap;
a valve that controls a flow of hot water in said tube; and
a tank capable of adjusting a temperature,
wherein in a state in which the extraction target is placed on the filter installed on said bottom surface member attached to said tubular member, hot water in said tank is poured from said through hole of said cap via said tube, and said plunger is then pushed in, thereby extracting an extract liquid from the extraction target.
